(19) United States
(12) Patent Application Publication
(10) Pub. No.: US 2003/0220897 A1
(43) Pub. Date: Nov. 27, 2003

(54) System and method for processing and analyzing patent information

(76) Inventors: Chung-I Lee, Tu-Chen (TW); Cai-Yang Luo, Shenzhen (CN); Zhi-Qiang Jiang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/273,587

(22) Filed: Oct. 18, 2002

(30) Foreign Application Priority Data
May 24, 2002 (TW) 91110973

(51) Int. Cl. G06F 7/00

(52) U.S. Cl. 707/1

(57) ABSTRACT

A system for processing and analyzing patent information includes a plurality of client computers (10), an application server (11), and a database (12). Each client computer includes an analysis type module (1010) for selecting an appropriate analysis type, a conditions-setting module (1011) for defining conditions of analysis, and an interactive user interface (100). A user selects an analysis type and defines conditions of analysis, which can include selecting aggregation and combination of patent information of different patent offices in various languages for analysis. The selected analysis type and defined conditions are transmitted to the application server, converted into a request in a predetermined format, and transmitted to the database. Patent information stored in the database is searched in accordance with the request, an analysis result is created, and the analysis result is transmitted to the user's client computer. Related methods for processing and analyzing of patent information are also disclosed.

### FIELD OF THE INVENTION

This invention is related to systems and methods for data processing and analyzing, and especially to systems and methods for integrally processing and analyzing patent information in different languages.

### BACKGROUND OF THE INVENTION

Patents are becoming more and more important to a manufacturing business's success, especially in today's globalized economy. Patents can be viewed as a new type of currency in this global economy. A good way to make use of patents is to search and analyze public patent databases, which are vast technological storehouses of information. The patent databases provide not only information on technologies but also information on inventors and assignees of inventions. To search and analyze the patent databases is valuable for conducting activities such as licensing, infringement litigation, enforcement, technical research, and product development. Nowadays, numerous government patent offices have patent databases open to the public. Such offices include the United States Patent and Trademark Office (USPTO), the European Patent Office (EPO), the State Intellectual Property Office of the People's Republic of China (CPO), and the Japanese Patent Office (JPO). These patent databases are freely accessible through their respective web sites on the Internet. However, few corporations conduct significant patent searching and analysis. One important reason for this is the difficulty in identifying relevant patents, and the difficulty in analyzing patents. Any major patent database contains an overwhelming number of patents, only a fraction of which are useful to a particular corporation. It is generally difficult for a corporation to efficiently search for useful patents. Even if the corporation finds useful patents, conducting patent analysis manually is a very difficult, tedious and time-consuming task.

There are some software tools for patent analysis currently available, such as Master Data Center (MDC) from Master Data Corporation. MDC is mainly used for managing corporate patent prosecution and payment of maintenance fees. However, the patent analysis capabilities of the MDC are limited. U.S. Pat. No. 5,991,751 provides another typical patent analysis tool called SmartPatent Workbench, which is provided by SmartPatents Inc. (SPI) of Mountain View, Calif. This patent provides tools for patent-centric and group-oriented data processing. SmartPatent Workbench is primarily designed to assist a user in analyzing patents by integration with non-patent information such as corporate operational data, financial information, production information, human resources information and other types of corporate information. The patent analysis functions include inventor patent count, patent aging, and patent citation. However, in some instances, a user needs to perform more detailed analysis tasks, such as an inventor patent count in each of several fields of technology. Another example is where a user needs to research patents owned by a particular corporation which are issued in various countries' patent offices such as the USPTO, CPO and JPO. It is difficult to automatically process patent information in different languages. The SmartPatent Workbench does not provide appropriate tools for such tasks. U.S. Pat. No. 6,339,767, owned by Aurigin Systems, Corp., is related to data processing tools that use hyperbolic trees to visualize data generated by patent-centric and group-oriented processing. This provides enhanced patent citation analysis and claim analysis beyond that provided by U.S. Pat. No. 5,991,751. However, like U.S. Pat. No. 5,991,751, this patent does not provide appropriate tools for the above-mentioned detailed analysis tasks.

### SUMMARY OF THE INVENTION

Accordingly, a primary object of the present invention is to provide a system and method for processing and analyzing patent information which can integrally analyze patent information in different languages.

Another object of the present invention is to provide a system and method for processing and analyzing patent information which provides users with multiple analysis functions based on one or more specific parameters.

In one aspect of the present invention, a system for processing and analyzing patent information is provided. The system provides processing and analyzing functions based on aggregation and combination of patent information in different languages. The system comprises a plurality of client computers, an application server, and a database. Each client computer includes an analysis type module for selecting an appropriate analysis type, a conditions-setting module for defining conditions of analysis, and an interactive user interface for accessing the analysis type module and the conditions-setting module. The application server is for receiving conditions of analysis from any of the client computers through an electronic communications network, and converting the conditions of analysis into a request in another predetermined format. The database receives the request, creates an analysis result, and transmits the analysis result to the application server.

In another aspect of the present invention, a method for processing and analyzing patent information provides processing and analyzing functions based on aggregation and combination of patent information in different languages. The method comprises the following steps: (a) providing a plurality of client computers, wherein each client computer includes an analysis type module for selecting an appropriate analysis type, a conditions-setting module for defining conditions of analysis, and an interactive user interface for accessing the analysis type module and the conditions-setting module; (b) providing an application server for receiving conditions of analysis from any of the client computers through an electronic communications network and converting the conditions of analysis into a request in another predetermined format; and (c) providing a database for receiving the request, creating an analysis result, and transmitting the analysis result to the application server.

In still another aspect of the present invention, a method for processing and analyzing patent information comprises the following steps: logging on a system for processing and analyzing patent information; opening a project as a current project; selecting an appropriate analysis type; defining conditions of analysis; converting the conditions into another predetermined format; creating an analysis result; and displaying the analysis result.

These and other objects and features of the present invention will become more fully apparent from the following description and appended claims, or may be learned by the practice of the invention as set forth hereinafter.

### BRIEF DESCRIPTION OF THE DRAWINGS

FIG. 1 is a schematic diagram of architecture of a system for processing and analyzing patent information in accordance with a preferred embodiment of the present invention;

FIG. 2 schematically illustrates a computer screen window for displaying patent information used in the system of FIG. 1;

FIG. 3 schematically illustrates a user interface (UI) for patent analysis in the system of FIG. 1; and

FIG. 4 is a flow chart of operation of the system of FIG. 1.

### DETAILED DESCRIPTION OF THE PREFERRED EMBODIMENT

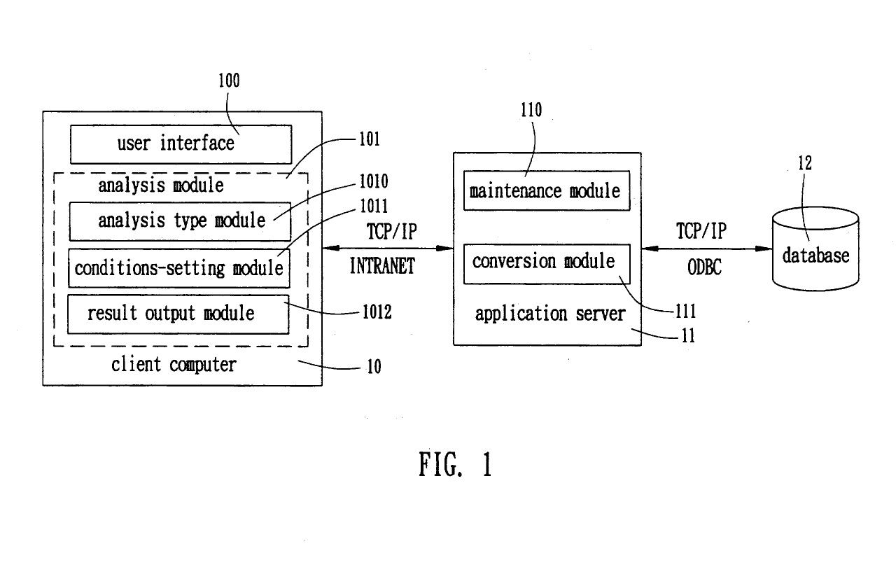

FIG. 1 is a schematic diagram of architecture of a system for processing and analyzing patent information in accordance with a preferred embodiment of the present invention. The system comprises a plurality of client computers 10 (only one shown), an application server 11, and a database 12. Each client computer 10 is connected with the application server 11 through an electronic communications network (not labeled). Such network may, for example, be an intranet which is based on Transfer Control Protocol or Internet Protocol (TCP/IP). The application server 11 interconnects with the database 12 by Open Database Connectivity (ODBC) based on TCP/IP.

Each client computer 10 is a personal computer, which comprises a user interface (UI) 100 and an analysis module 101. The UI 100 provides users an interactive interface for accessing and storing information. The analysis module 101 provides users with multiple analysis functions, and comprises the following three modules: an analysis type module 1010, a conditions-setting module 1011, and a result output module 1012. The analysis type module 1010 is provided for selecting an appropriate type of analysis. In the preferred embodiment, available analysis types include: patent date analysis (including application date and issue date), inventor analysis, assignee analysis, technology field analysis, agent analysis, attorney analysis, priority analysis, examiner analysis, and citation analysis. Each analysis type refers to a statistical analysis function based on one or more parameters. For example, the patent date analysis enables a user to obtain a count of patents for each of time units selected in a selected time frame. The inventor analysis enables a user to obtain a count of patents invented by each inventor whose name appears in a selected collection of patents. The assignee analysis enables a user to obtain a count of patents owned by each assignee involved in the collection of patents. The technology field analysis enables a user to obtain a count of patents in each field of technology. Technology fields can be classified according to a classification system selected by the user. Such classification systems include International Patent Classification (IPC), U.S. Patent Classification (UPC), and User Defined Classification (UDC). The agent/attorney analysis enables a user to obtain a count of patents prosecuted by each agent/attorney. The examiner analysis enables a user to obtain a count of patents examined by each examiner. The priority analysis enables a user to obtain a count of patents in each priority country. The citation analysis enables a user to obtain a count of patents cited by a specific patent, to obtain a count of patents which cite the specific patent, and to visualize all the cited and citing patents using a configurable tree. Moreover, each of these analysis types can be used in combination with other of these analysis types. For example, the inventor analysis enables a user to obtain a count of inventor patents in each field of technology involved in the collection of patents. The conditions-setting module 1011 is used for defining conditions of analysis, including range of dates, technology field and patent office (PO). The result output module 1012 is used for displaying and outputting analysis results. If an analysis result is a statistical chart, the result can be automatically output in a predetermined file format such as a Microsoft Excel file. If the analysis result is something else such as an image, the result can be stored automatically in a predetermined file format according to a defined path.

The application server 11 comprises a maintenance module 110 and a conversion module 111. The maintenance module 110 is used for adding, updating and deleting user information, and for assigning different access authorities to various users. System administrators have the highest authority. Only system administrators can add, update and delete users. Users include supervisors and common users. A common user can only undertake a project defined for him/her, unless the common user's supervisor authorizes the common user to undertake other projects. The conversion module 111 is used for converting conditions defined by users through the conditions-setting module 1011 into a request in a predetermined format such as Structured Query Language (SQL). The request can then be recognized by the database 12.

The database 12 stores all patent information downloaded from various patent office databases. All the patent information is related to various projects defined by users. These projects can be based on a specific field of technology, on a specific assignee, or on other specific parameters. Each project has a collection of patents. When a user opens a project on the system, the system automatically reads patent information related to the project.

A users opens a project on the system, selects an appropriate type of analysis, and defines conditions of analysis through the client computer 10. The analysis type and conditions are converted into a search request in the predetermined format through the application server 11. Upon receiving the search request, the database 12 automatically searches the patent information according to the search request and counts matching patents. Finally, the amount of matching patents counted by the database 12 is transmitted to the client computer 10 through the application server 11, and displayed through the result output module 1012.

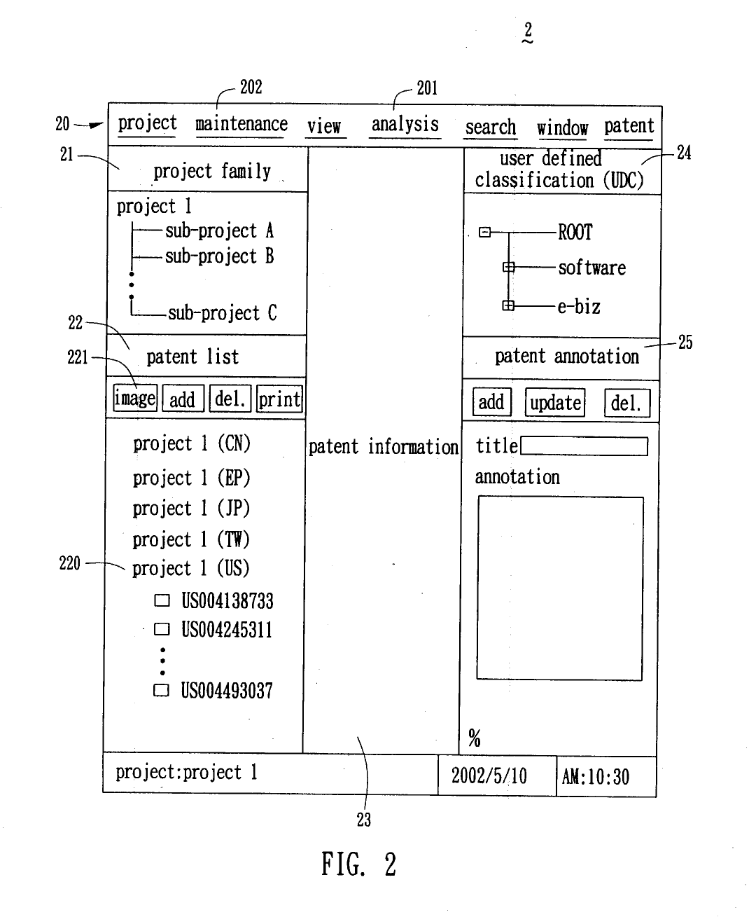

FIG. 2 schematically illustrates a computer screen window 2 for displaying patent information used in the system of FIG. 1. A group of main menus 20 is displayed at a top of the window 2. The main menus 20 comprise an analysis menu 201 for selecting an analysis type, and a maintenance menu 202. Five sub-windows 20˜24 are displayed below the main menus 20. In the preferred embodiment, the sub-windows are dock windows. Each dock window may be an independent window, or may be dragged by users to any position on the window 2 to become a part of the window 2. Sub-window 21 shows a project family, including a current project and all sub-projects of the current project. Each sub-project is a subset of the current project. Sub-window 22 shows a patent list related to the current project. Patents related to the current project are divided into different groups, such as project 1 (CN), project 1 (EP), project 1 (JP), project 1 (TW), and project 1 (US) 220. Each group is a collection of patents downloaded from a specific patent office database. For example, project 1 (US) 220 is a collection of patents downloaded from the USPTO. By double clicking one of the groups, the patent list for the group can be spread or hidden. Each patent in the patent list has an adjacent icon. Sub-window 23 is provided for displaying patent information. When a patent in the window 22 is highlighted, information on that patent is displayed in sub-window 23. The patent information may be text or patent images. Text information includes patent name, abstract, application and issue dates, inventor, assignee, technological classification, and cited references. A button 221 in sub-window 22 is used for switching the display screen between text information and patent images. Sub-window 24 shows user defined classification (UDC), which can be added to, updated and deleted by users through the maintenance menu 202. A user can designate an appropriate UDC for a selected patent, and then drag the selected patent from the patent list in sub-window 22 onto the designated UDC. Thereupon, the patent is listed under the designated UDC, and the icon adjacent the patent in the patent list turns green. Sub-window 25 is used for annotating the selected patent.

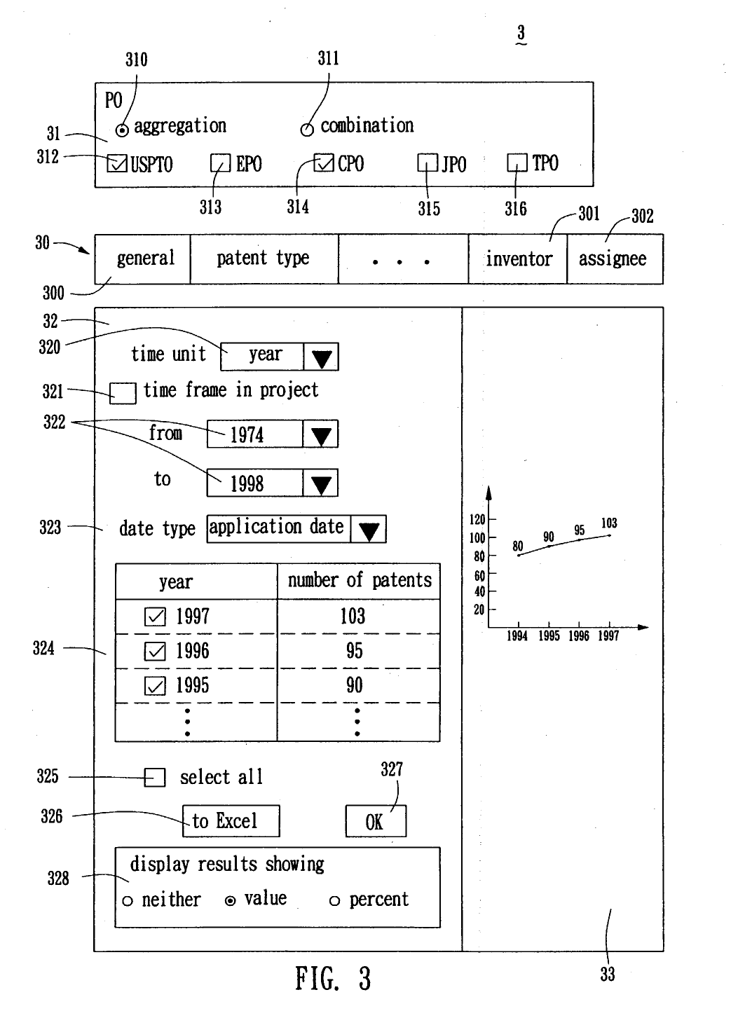

FIG. 3 schematically illustrates a user interface (UI) 3 of the system. The UI 3 is for a user to analyze patents. The system provides many analysis types, as described above in relation to FIG. 1. However, the UI 3 illustrated in FIG. 3 relates to date analysis only. Accordingly, the following detailed description of the UI 3 is in relation to date analysis. A plurality of tabs 30 is arranged across an upper middle portion of the UI 3, for switching between different tabbed pages. The tabs comprise a general tab 300, an inventor tab 301, and an assignee tab 302. Each corresponding tabbed page shows a UI 3 for a corresponding analysis type. The general tab 300 provides analysis based on a defined time range. The other tabs provide analysis based on a combination of a defined time range and another parameter. For example, the inventor tab 301 provides analysis based on a combination of a time range and one or more inventors, and the assignee tab 302 provides analysis based on a combination of a time range and one or more assignees. A frame 31 at a top of the UI 3 enables the user to define a range of patent information for analysis. The frame 31 comprises five check-boxes 312˜316 each representing patent information of a respective patent office (PO). For example, the check-box 312 represents patent information of the USPTO, and the check-box 314 represents patent information of the CPO. A radio button 310 in the frame 31 represents aggregation of patent information of all selected patent offices. For example, if the check boxes 312 and 314 are checked, the radio button represents aggregation of patent information of the USPTO and the CPO. For example, if a number of patents obtained by checking only the check-box 312 is A, and a number of patents obtained by checking only the check-box 314 is B, the number of patents obtained by selecting the radio button 310 is the sum of A and B. Another radio button 311 in the frame 31 represents a combination of selected patent information. For example, if the check-boxes 312 and 314 are checked, A patents of the USPTO and B patents of the CPO are displayed synchronously in one statistical chart and contrasted with each other.

The tabbed page below the tabs 30 is divided into two forms 32, 33. Form 32 is used for defining conditions for analysis, and form 33 is used for previewing analysis results. In form 32, a dropdown menu 320 is used for selecting a suitable time unit. Time units include year, half year, and month. A check-box 321 represents a time frame in the current project. If the check-box 321 is checked, a time frame is automatically displayed by a pair of dropdown menus 322. If the check-box 321 is not checked, the user can manually input a desired time frame. A dropdown menu 323 is used for selecting date type, which may be application date or publication date. If application date is selected, analysis is performed based on application dates. If publication date is selected, analysis is performed based on publication dates. According to the selected time unit and time frame, the system automatically shows each time unit and its corresponding number of patents in a listview 324. The user can select all time units by checking a check-box 325. Alternatively, the user can select desired time units by manually checking corresponding check-boxes adjacent each time unit. The listview 324 only displays a number of patents, and only for time units which have been checked. After defining the above conditions and clicking an OK button 327, the analysis result is automatically displayed in form 33 for the user to review. The user can output the analysis result by clicking a button 326. In the preferred embodiment of the present invention, the analysis result can be output to an Excel file. In order to make a displayed statistical chart in form 33 more readable, the user can change a mode of presentation of the results using radio buttons in a frame 328. In the preferred embodiment of the present invention, selectable modes of presentation are by value, by percent, and neither. Neither means that neither values nor percentages are presented.

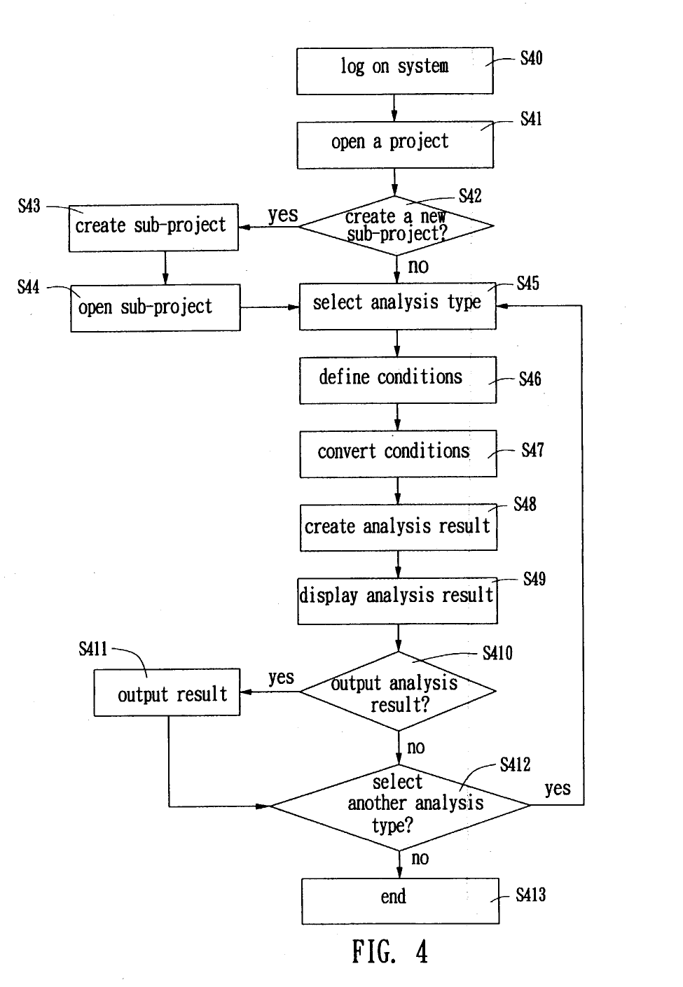

FIG. 4 is a flow chart of operation of the system of the present invention. Firstly, in step S40, a user logs on the system with a user ID and password assigned by system administrators. In step S41, the user opens a project. The project opened is hereinafter called a current project. In step S42, the user determines whether to create a new sub-project of the current project. For example, if the current project is based on a specific field of technology, the user can create a new sub-project based on main assignees. If the user does not create a new sub-project, then the operation proceeds directly to step S45 as described below. If the user creates a new sub-project, then in step S43 the user creates the new sub-project by searching patent information of the current project. In step S44, the user opens the sub-project for analysis, whereupon the operation proceeds to step S45. In step S45, the user selects a desired analysis type by selecting the appropriate tab 30 in the UI 3. Instep S46, the user defines conditions for analysis through the UI 3. In step S47, the conditions for analysis are transmitted to the application server 11, and automatically converted into the request in the predetermined format that can be recognized by the database 12. In step S48, patent information stored in the database 12 is searched in accordance with the request, and an analysis result is created. In step S49, the analysis result is transmitted to the client computer 10 through the application server 11, and displayed in a statistical chart format. In step S410, the user decides whether to output the analysis result. If the decision is no, then the operation proceeds directly to step S412 as described below. If the decision is yes, then in step S411 the analysis result is output to a predetermined file format such as an Excel file format, whereupon the operation proceeds to step S412. In step S412, the user decides whether to select another analysis type. If the decision is yes, then the operation returns to step S45 and the applicable above-described steps. If the decision is no, then in step S413 the operation is ended.

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A system for processing and analyzing patent information, the system comprising:
a plurality of client computers, each of the client computers including:
an analysis type module for selecting a desired type of analysis;
a conditions-setting module for defining conditions of analysis; and
an interactive user interface for accessing the analysis type module and the conditions-setting module;
an application server for receiving conditions of analysis defined in any of the client computers through an electronic communications network and converting the conditions of analysis into a request in another predetermined format; and
a database for receiving the request, creating an analysis result, and transmitting the analysis result to the application server.

2. The system for processing and analyzing patent information as claimed in claim 1, wherein the conditions-setting module enables a user to select aggregation of patent information of different patent offices for analysis.

3. The system for processing and analyzing patent information as claimed in claim 1, wherein the conditions-setting module enables a user to select a combination of patent information of different patent offices for analysis.

4. The system for processing and analyzing patent information as claimed in claim 2, wherein the patent information is automatically downloaded from different patent offices.

5. The system for processing and analyzing patent information as claimed in claim 1, wherein types of analysis include application date analysis and issue date analysis enabling a user to obtain a count of patents for each of time units selected in a selected time frame.

6. The system for processing and analyzing patent information as claimed in claim 1, wherein types of analysis include inventor analysis enabling a user to obtain a count of patents invented by each inventor whose name appears in a selected collection of patents.

7. The system for processing and analyzing patent information as claimed in claim 1, wherein types of analysis include assignee analysis enabling a user to obtain a count of patents owned by each assignee involved in a selected collection of patents.

8. The system for processing and analyzing patent information as claimed in claim 1, wherein types of analysis include technology field analysis enabling a user to obtain a count of patents in each field of technology.

9. The system for processing and analyzing patent information as claimed in claim 8, wherein technology fields can be classified according to a classification system selected by the user.

10. The system for processing and analyzing patent information as claimed in claim 1, wherein types of analysis include agent analysis enabling a user to obtain a count of patents prosecuted by each agent.

11. The system for processing and analyzing patent information as claimed in claim 1, wherein types of analysis include attorney analysis enabling a user to obtain a count of patents prosecuted by each attorney.

12. The system for processing and analyzing patent information as claimed in claim 1, wherein types of analysis include examiner analysis enabling a user to obtain a count of patents examined by each examiner.

13. The system for processing and analyzing patent information as claimed in claim 1, wherein types of analysis include priority analysis enabling a user to obtain a count of patents in each priority country.

14. The system for processing and analyzing patent information as claimed in claim 1, wherein types of analysis include citation analysis enabling a user to obtain a count of patents cited by a particular patent, to obtain a count of patents which cite the particular patent, and to visualize all the cited and citing patents using a configurable tree.

15. A method for processing and analyzing patent information, the method comprising the following steps:
(a) providing at least one client computer including:
an analysis type module for selecting an appropriate type of analysis;
a conditions-setting module for defining conditions of analysis; and
an interactive user interface for accessing the analysis type module and the conditions-setting module;
(b) providing an application server for receiving conditions defined in the at least one client computer through an electronic communications network and converting the conditions into a request in another predetermined format; and
(c) providing a database for receiving the request, creating an analysis result, and transmitting the analysis result to the application server.

16. The method for processing and analyzing patent information as claimed in claim 15, wherein defined conditions include selecting aggregation of patent information of different patent offices for analysis.

17. The method for processing and analyzing patent information as claimed in claim 15, wherein defined conditions include selecting a combination of patent information of different patent offices for analysis.

18. The method for processing and analyzing patent information as claimed in claim 15, wherein step (c) further comprises the following steps:
transmitting the analysis result from the application server to the at least one client computer; and
displaying the analysis result on the interactive user interface.

19. The method for processing and analyzing patent information as claimed in claim 15, wherein step (c) further comprises the step of outputting the analysis result into a file in a predetermined form.

20. A method for processing and analyzing patent information, the method comprising the following steps:
selecting an appropriate type of analysis;
defining conditions of analysis;
converting the conditions into another predetermined format;
creating an analysis result; and
displaying the analysis result.

21. The method for processing and analyzing patent information as claimed in 20, further comprising the following steps:
creating a sub-project; and
opening the sub-project for analysis.

22. A method of analyzing intellectual property (IP) relating to a technology from different sources, comprising:
defining a specific inquiry category relating to said technology;
accessing a first IP database to retrieve corresponding IP information meeting said category wherein said first IP database uses a first language;
accessing a second IP database to retrieve corresponding IP information meeting said category wherein said second IP database uses a second language different from the first language; wherein at least a portion of the IP information retrieved from the first database is essentially identical to a corresponding portion of the IP information retrieved from the second database.

23. The method as claimed in claim 22, wherein retrieval in the first IP database is independent of that in the second IP database even though both use the same inquiry category.

24. The method as claimed in claim 22, wherein said first and second languages refer to speaking/writing languages.

25. The method as claimed in claim 22, wherein said first IP database and said second database refer to national patent databases of different nations, which were stored by formats and languages different from each other.

26. The method as claimed in claim 22, further including a steps of accessing a third IP database using a third languages different from the first and second languages.
